(19) United States
(12) Patent Application Publication
(10) Pub. No.: US 2022/0288638 A1
(43) Pub. Date: Sep. 15, 2022

(54) ROTATING MEMBER COMBINATION APPARATUS AND CONNECTING SHAFT THEREFOR

(71) Applicant: Jinan Haote Innovation Management and Consulting Partnership (Limited Partnership), Jinan (CN)

(72) Inventors: Xianhua ZHAO, Jinan (CN); Yang WANG, Jinan (CN); Xiujuan LIU, Jinan (CN); Zhiming ZHAO, Jinan (CN)

(73) Assignee: Jinan Haote Innovation Management and Consulting Partnership (Limited Partnership), Jinan (CN)

(21) Appl. No.: 17/632,296

(22) PCT Filed: Jul. 28, 2020
(86) PCT No.: PCT/CN2020/105176

§ 371 Date: Feb. 2, 2022

(30) Foreign Application Priority Data
Aug. 9, 2019 (CN) 201921288237.9
Aug. 9, 2019 (CN) 201921289159.4

(51) Int. Cl. B06B 1/16

(52) U.S. Cl. CPC B06B 1/166

(57) ABSTRACT

A rotary member combination device and a connecting shaft thereof are provided. The rotary member combination device includes at least a first rotary member and a second rotary member, and further includes a connecting shaft between the first rotary member and the second rotary member. At least one of the first rotary member or the second rotary member is connected to the connecting shaft by a spiral groove and a boss structure matching the spiral groove. For the connecting shaft used in the rotary member combination device, the connecting shaft is provided with a first boss or a third spiral groove matching the first rotary member of the rotary member combination device. Compared with the prior art, the connecting shaft provided in the present invention may connect two or more rotary members to implement a relative positional relationship of the two or more rotary members in a circumferential direction, an adjustment process does not require any state condition, and relative positions of the rotary members in the circumferential direction may be controlled in a stationary state or at any rotational speed. The control accuracy is high, the control mode is flexible, and a mode such as manual adjustment, electrical automatic control, hydraulic adjustment, or pneumatic adjustment may be implemented.

### TECHNICAL FIELD

The present invention relates to a combination device of a plurality of rotary members, and in particular, to a device in which relative positions of a plurality of rotary members adjustable in a circumferential direction and a connecting shaft thereof.

### BACKGROUND

In the field of mechanical device technologies, many combination devices with two or more rotary members involve adjustment of relative positions of the rotary members in a circumferential direction of the rotary members, for example, adjustment of relative positions of a plurality of rotary members in a circumferential direction of the rotary members in a device such as an eccentric mechanism, a gear train, or an axle. In the prior art, relative positions of two or more rotary members in a circumferential direction can only be adjusted by manually adjusting and locking positions of the two or more rotary members when a rotary member combination device is stationary. For example, a method for adjusting an eccentricity of a vibrator is disclosed in the specification of Chinese Utility Model Patent No. 200920308697.3 and entitled “Vibrator”. In the method, a fastening screw is manually unscrewed by a wrench, and relative positions of two eccentrics in a circumferential direction is adjusted. The screw is tightened after the eccentricity is adjusted. This mode of adjusting relative positions in a circumferential direction in a rotary member combination device is complex to operate and is not suitable for automatic control. To implement automatic adjustment, it is mentioned in the article Design and Analysis of Inertia Vibrator with Adjustable Eccentric Mass published by DUAN Xinhao et al. from North China Institute of Aerospace Engineering in Mechanical Strength, Issue 01, 2018 that an uneven distribution of a liquid in a rotary member is controlled to generate an eccentric force. The disadvantage of using this mode is that each component requires no liquid leakage and high manufacturing accuracy. In addition, a liquid generally has a small density, and a large eccentric mass is required to generate a large exciting force, resulting in a relatively large volume of the vibrator. In addition, the control in this adjustment mode requires complex electrical equipment, manufacturing and operating costs of the equipment are high, and it is not easy to ensure the accuracy of adjusting an exciting force.

### SUMMARY

In view of the deficiencies of the prior art, the present invention provides a rotary member combination device that is suitable for automatic control, has a simple structure, and can ensure the adjustment accuracy of relative positions of a plurality of rotary members in a circumferential direction.

A rotary member combination device includes at least a first rotary member (1) and a second rotary member (2), and further includes a connecting shaft (3) between the first rotary member (1) and the second rotary member (2). At least one of the first rotary member (1) or the second rotary member (2) is connected to the connecting shaft (3) by a spiral groove and a boss structure matching the spiral groove.

In the rotary member combination device provided in the present invention, axial positions of the first rotary member (1) and the second rotary member (2) may be fixed by a fixing device. In this case, only an angle between the first rotary member (1) and the second rotary member (2), that is, relative positions of the first rotary member (1) and the second rotary member (2) in a circumferential direction, can be adjusted. Alternatively, the axial positions of the first rotary member (1) and the second rotary member (2) may not be fixed by the fixing device. In this case, the angle between the first rotary member (1) and the second rotary member (2), that is, the relative positions in the circumferential direction, can be adjusted, and an axial interval between, that is, relative positions of the first rotary member (1) and the second rotary member (2) in an axial direction may also be simultaneously adjusted.

The axial position fixing device bearing may be a shaft hole matching boss, a positioning roller, a bearing, or another axial fixing device.

Preferably, the axial position fixing device bearing is a bearing.

In one of the solutions of the rotary member combination device provided in the present invention, a first spiral groove (11) is provided in an inner wall of a shaft hole of the first rotary member (1), and a first boss (31) matching the first spiral groove (11) is disposed on the connecting shaft (3).

There may be one or more first bosses (31). To improve the connection stability between the first rotary member (1) and the connecting shaft (3), there are two or more first bosses (31), and the two or more first bosses (31) are distributed on a spiral track line matching the first spiral groove (11).

Further, a second spiral groove (21) that rotates in an opposite direction from the first spiral groove (11) is provided in an inner wall of a shaft hole of the second rotary member (2), and a second boss (32) matching the second spiral groove (21) is disposed on the connecting shaft (3).

There may be one or more second bosses (32). To improve the connection stability between the second rotary member (2) and the connecting shaft (3), there are two or more second bosses (32), and the two or more second bosses (32) are distributed on a spiral track line matching the second spiral groove (21).

Preferably, axial positions of the first rotary member (1) and the second rotary member (2) are fixed by a fixing device.

A method for adjusting the relative positions of the plurality of rotary members in the circumferential direction in the rotary member combination device in the foregoing mode is as follows.

The connecting shaft (3) is axially pushed to move forward or backward. Because the axial positions of the first rotary member (1) and the second rotary member (2) are fixed by the axial position fixing device bearing, the forward or backward movement of the connecting shaft (3) drives the first boss (31) and the second boss (32) on the connecting shaft (3) to move forward or backward, drives the first spiral groove (11) and the second spiral groove (21) to rotate opposite each other in the circumferential direction, and drives the first rotary member (1) and the second rotary member (2) to rotate in opposite directions, so that the accurate adjustment of the relative positions of the plurality of rotary members in the circumferential direction is implemented.

In another solution, the second rotary member (2) is fixedly connected to the connecting shaft (3), the axial position of the first rotary member (1) is not fixed, a shifting device is disposed on the first rotary member (1), and the shifting device may move forward or backward in an axial direction to actuate the axial position of the first rotary member (1).

Preferably, the shifting device is a shifting fork, the shifting fork is provided with a U-shaped groove, and the first rotary member (1) is placed in the U-shaped groove of the shifting fork. The shifting fork actuates the first rotary member (1) to axially move to reach a specified position and locks the axial position of the first rotary member (1).

Preferably, the second rotary member (2) is integrated with the connecting shaft (3), a front end is the connecting shaft (3), and a rear end is the second rotary member (2).

A method for adjusting the relative positions of the rotary members in the circumferential direction in the rotary member combination device is: shifting the shifting device on the first rotary member (1) to drive the first rotary member (1) to move forward or backward on the connecting shaft (3), driving the first spiral groove (11) to move forward or backward, driving the first boss (31) to rotate, driving the connecting shaft (3) to rotate, driving the second rotary member (2) to rotate, and making the relative positions of the second rotary member (2) and the first rotary member (1) in the circumferential direction change, so that the adjustment of the relative positions of the two rotary members in the circumferential direction and a change of the axial positions of the two rotary members are implemented.

In still another solution, an axial position of the connecting shaft (3) is fixed by an axial position fixing device bearing, neither the axial positions of the first rotary member (1) nor the second rotary member (2) is fixed, at least one of the first rotary member (1) or the second rotary member (2) is provided with a shifting device, and the first rotary member (1) or/and the second rotary member (2) respectively or separately moves/move in an axial direction under the actuation of the shifting device.

In a first case of the foregoing solution, the first rotary member is provided with a first shifting device (5).

A method for adjusting the relative positions of the rotary members in the circumferential direction in the rotary member combination device is as follows. The first shifting device (5) is shifted to move leftward or rightward and drives the first rotary member (1) to move leftward or rightward. Because the axial position of the connecting shaft (3) is fixed, a movement of the first rotary member (1) in the axial direction drives the connecting shaft (3) to rotate in the circumferential direction, and drives the second rotary member (2) to rotate in the circumferential direction, so that the adjustment of the relative positions of the two rotary members in the circumferential direction is implemented.

In a second case of the foregoing solution, the first rotary member is provided with a first shifting device (5), and the second rotary member is provided with a second shifting device (6).

A method for adjusting the relative positions of the rotary members in the circumferential direction in the rotary member combination device is as follows. The first shifting device (5) is shifted to move forward or backward and drives the first rotary member (1) to move forward or backward in the axial direction. Because the axial position of the connecting shaft (3) is fixed, a movement of the first rotary member (3) in the axial direction drives the rotation of the connecting shaft (3) in the circumferential direction, and drives the second rotary member (2) to rotate in the circumferential direction. The second shifting device (6) is reversely shifted to move backward or forward. A reverse movement of the second rotary member (2) in the axial direction further drives the rotation of the connecting shaft in the circumferential direction, and further drives the second rotary member (2) to rotate in the circumferential direction, so that the implementation of adjusting the relative positions of the two rotary members in the circumferential direction is accelerated, that is, the first rotary member (1) and the second rotary member (2) rotate opposite each other in the circumferential direction while approaching or moving away from each other in the axial direction, so as to implement the adjustment of the relative positions of the two rotary members in the circumferential direction.

Alternatively, a first linear groove (22) is provided in an inner wall of the shaft hole of the second rotary member (2), and a second boss (32) mounted in conjunction with the first linear groove (22) is disposed on the connecting shaft (3).

There may be one or more first linear grooves (22). To improve the connection stability between the second rotary member (2) and the connecting shaft (3), there are two or more first linear grooves (22), and preferably, the two or more first linear grooves (22) are equiangularly distributed in a circumferential direction of the inner wall of the shaft hole of the second rotary member (2). Preferably, there are two or more second bosses (32), and the two or more second bosses (32) are distributed at positions matching the first linear grooves (22).

A shape of each boss may be any shape that can match the spiral groove or the linear groove, and for example, may be a cylindrical shape, or a spiral boss shape matching a shape of each spiral groove. To reduce the frictional force when the spiral groove and the spiral boss slide and reduce the manufacturability of processing, the spiral boss may be discontinuous.

A method for adjusting the relative positions of the plurality of rotary members in the circumferential direction in the rotary member combination device in the foregoing mode is as follows.

The connecting shaft (3) is axially pushed to move forward or backward. Because the axial positions of the first rotary member (1) and the second rotary member (2) are fixed by the axial position fixing device bearing, the forward or backward movement of the connecting shaft (3) drives the first boss (31) and the second boss (32) on the connecting shaft (3) to move forward or backward, drives the first spiral groove (11) to rotate while the first linear groove (22) remains stationary, and drives the first rotary member (1) to rotate while the second rotary member (2) remains stationary in the first linear groove (22), so that the accurate adjustment of the relative positions of the plurality of rotary members in the circumferential direction is implemented.

In still another solution, a third spiral groove (34) is provided in the connecting shaft (3), and a third boss (12) mounted in conjunction with the third spiral groove (34) is disposed on the first rotary member (1).

There may be one or more third bosses (12). To improve the connection stability between the first rotary member (1) and the connecting shaft (3), there are two or more third bosses (12), and the two or more third bosses are distributed on a spiral track line matching the third spiral groove.

Further, a fourth spiral groove (35) that rotates in an opposite direction from the third spiral groove (34) is provided in the connecting shaft (3), and a fourth boss (23) mounted in conjunction with the fourth spiral groove (35) is disposed on the second rotary member (2).

There may be one or more fourth bosses (23). To improve the connection stability between the second rotary member (2) and the connecting shaft (3), there are two or more fourth bosses (23), and the two or more fourth bosses are distributed on a spiral track line matching the fourth spiral groove (35).

Preferably, axial positions for arranging the rotary members with the spiral grooves in the first rotary member (1) and the second rotary member (2) are fixed by a fixing device.

A method for adjusting the relative positions of the plurality of rotary members in the circumferential direction in the rotary member combination device in the foregoing mode is as follows.

The connecting shaft (3) is axially pushed to move forward or backward. Because the axial positions of the first rotary member (1) and the second rotary member (2) are fixed by the axial position fixing device bearing, the forward or backward movement of the connecting shaft (3) drives the third spiral groove (34) and the fourth spiral groove (35) on the connecting shaft (3) to move forward or backward, drives the third boss (12) and the fourth boss (23) to rotate in opposite directions, and drives the first rotary member (1) and the second rotary member (2) to rotate in opposite directions, so that the accurate adjustment of the relative positions of the plurality of rotary members in the circumferential direction is implemented.

Alternatively, a second linear groove (36) is provided in the connecting shaft (3), and a fourth boss (23) mounted in conjunction with the second linear groove (36) is disposed on the second rotary member (2).

There may be one or more second linear grooves (36). To improve the connection stability between the second rotary member (2) and the connecting shaft (3), there are two or more second linear grooves (36), and the two or more second linear grooves (36) are equiangularly distributed in a circumferential direction of the connecting shaft (3). There are two or more fourth bosses (23), and the two or more fourth bosses are distributed at positions matching the second linear grooves.

A shape of each boss may be any shape that can be mounted in conjunction with the spiral groove or the linear groove, and for example, may be a cylindrical shape, or a spiral boss shape matching the shape of the spiral groove. To reduce the frictional force when the spiral groove and the spiral boss slide and reduce the manufacturability of processing, the spiral boss may be discontinuous.

Preferably, axial positions for arranging the rotary members with the spiral grooves in the first rotary member (1) and the second rotary member (2) are fixed by a fixing device.

A method for adjusting the relative positions of the plurality of rotary members in the circumferential direction in the rotary member combination device in the foregoing mode is as follows.

The connecting shaft (3) is axially pushed to move forward or backward. Because the axial positions of the first rotary member (1) and the second rotary member (2) are fixed by the axial position fixing device bearing, the forward or backward movement of the connecting shaft (3) drives the third spiral groove (34) and the second linear groove (36) on the connecting shaft (3) to move forward or backward, drives the third boss (12) to rotate, and drives the first rotary member (1) to rotate, the fourth boss (23) remains stationary, and the second rotary member (2) remains stationary, so that the accurate adjustment of the relative positions of the plurality of rotary members in the circumferential direction is implemented.

Alternatively, an axial position of the connecting shaft (3) is fixed by an axial position fixing device bearing, neither the axial positions of the first rotary member (1) nor the second rotary member (2) is fixed, at least one of the first rotary member (1) or the second rotary member (2) is provided with a shifting device, and the first rotary member (1) or/and the second rotary member (2) respectively or separately moves/move in the axial direction under the actuation of the shifting device. A method for adjusting the relative positions of the plurality of rotary members in the circumferential direction in the rotary member combination device is the same as that described above.

Compared with the prior art, the rotary member combination device provided in the present invention achieves that for two or more rotary members, relative positions of the rotary members in a circumferential direction can be adjusted with high accuracy only by a simple mechanical structure, an adjustment process does not require any state condition, and the relative positions of the rotary members in the circumferential direction may be controlled in a stationary state or at any rotational speed. The control accuracy is high, the control mode is flexible, and a mode such as manual adjustment, electrical automatic control, hydraulic adjustment, or pneumatic adjustment may be adopted.

A connecting shaft used in the rotary member combination device is provided. A boss or spiral groove structure may be provided in the connecting shaft.

When a boss structure is disposed on the connecting shaft, the following structure may be adopted:

The connecting shaft is provided with a first boss (31) matching the first rotary member of the rotary member combination device. The first boss (31) may be a cylinder, a spiral boss, or another shape that can be match a spiral groove.

When the first boss (31) adopts a cylindrical shape, the connecting shaft includes, but not limited to, the following structural cases.

In one case, there is at least one cylindrical first boss (31). Preferably, there are two or more cylindrical first bosses (31), and the two or more first bosses (31) are disposed on a track line of the first spiral groove.

Further, the connecting shaft is fixedly connected to the second rotary member of the rotary member combination device.

Alternatively, the connecting shaft is provided with a cylindrical second boss (32) matching the second rotary member of the rotary member combination device, and there is at least one second boss (32). Preferably, there are two or more second bosses (32), and the two or more second bosses (32) are disposed on a second spiral track line rotating in an opposite direction from the first spiral groove.

In another case, the connecting shaft is provided with a first linear boss (33) matching the second rotary member of the rotary member combination device.

Preferably, there are two or more first linear bosses (33), and the two or more first linear bosses (33) are equiangularly distributed in a circumferential direction of the connecting shaft.

When the first boss (31) adopts a spiral boss shape, the connecting shaft includes, but not limited to, the following structural cases.

In one case, the first boss (31) is a first spiral boss (37).

Further, the connecting shaft is fixedly connected to the second rotary member of the rotary member combination device; alternatively, the connecting shaft is provided with a second spiral boss (38) matching the second rotary member of the rotary member combination device. A right end of the connecting shaft is provided with a first linear boss (33) matching the second rotary member of the rotary member combination device.

Preferably, there are two or more first linear bosses (33), and the two or more first linear bosses (33) are equiangularly distributed in a circumferential direction of the connecting shaft.

When the spiral groove structure is provided in the connecting shaft, the following structure may be adopted:

The connecting shaft is provided with a third spiral groove (34) matching the first rotary member of the rotary member combination device.

Further, a fourth spiral groove (35) that rotates in an opposite direction from the third spiral groove (34) is provided in the connecting shaft.

Alternatively, the connecting shaft is fixedly connected to the second rotary member of the rotary member combination device.

Alternatively, a second linear groove (36) is provided in the connecting shaft.

Preferably, there are two or more second linear grooves (36), and the two or more second linear grooves (36) are equiangularly distributed in a circumferential direction of the connecting shaft.

Compared with the prior art, the connecting shaft provided in the present invention may connect two or more rotary members to implement a relative positional relationship of the two or more rotary members in a circumferential direction, an adjustment process does not require any state condition, and relative positions of the rotary members in the circumferential direction may be controlled in a stationary state or at any rotational speed. The control accuracy is high, the control mode is flexible, and a mode such as manual adjustment, electrical automatic control, hydraulic adjustment, or pneumatic adjustment may be adopted.

### BRIEF DESCRIPTION OF THE DRAWINGS

FIG. 1 is a schematic structural diagram of Embodiment 1;

FIG. 2 is a schematic structural diagram of a connecting shaft in Embodiment 1;

FIG. 3 is a schematic structural diagram of Embodiment 2;

FIG. 4 is a schematic structural diagram of a connecting shaft and a second rotary member in Embodiment 2;

FIG. 5 is a schematic structural diagram of Embodiment 3;

FIG. 6 is a schematic structural diagram of a connecting shaft in Embodiment 4 and Embodiment 6;

FIG. 7 is a schematic structural diagram of a connecting shaft and a second rotary member in Embodiment 5;

FIG. 8 is a schematic structural diagram of Embodiment 7;

FIG. 9 is a schematic structural diagram of a connecting shaft in Embodiment 7;

FIG. 10 is a schematic structural diagram of Embodiment 8;

FIG. 11 is a schematic structural diagram of a connecting shaft in Embodiment 9 and Embodiment 10;

FIG. 12 is a schematic structural diagram of Embodiment 11;

FIG. 13 is a schematic structural diagram of a connecting shaft in Embodiment 11;

FIG. 14 is a schematic structural diagram of a connecting shaft and a second rotary member in Embodiment 12;

FIG. 15 is a schematic structural diagram of Embodiment 14; and

FIG. 16 is a schematic structural diagram of a connecting shaft in Embodiment 14 and Embodiment 15;

Here: 1. First rotary member; 2. Second rotary member; 3. Connecting shaft; 4. Fixing device; 5. First shifting device; 6. Second shifting device; 11. First spiral groove; 12. Third boss; 21. Second spiral groove; 22. First linear groove; 23. Fourth boss; 31. First boss; 32. Second boss; 33. First linear boss; 34. Third spiral groove; 35. Fourth spiral groove; 36. Second linear groove; 37. First spiral boss; and 38. Second spiral boss.

### DETAILED DESCRIPTION

The innovative content of the present invention is described below in detail with reference to the accompanying drawings.

### Embodiment 1

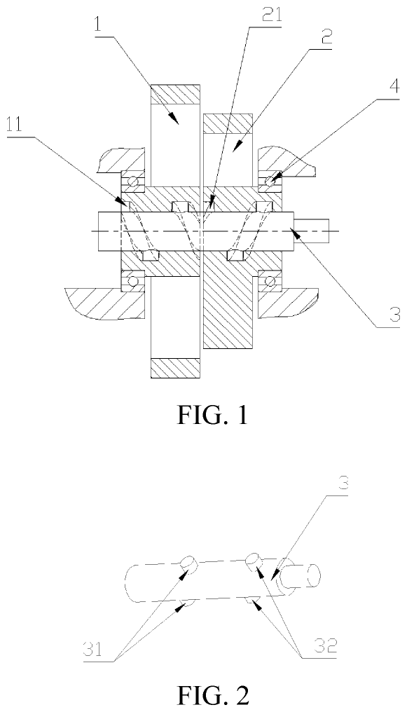

As shown in FIG. 1, a rotary member combination device includes a first rotary member 1, a second rotary member 2, and a connecting shaft 3. The first rotary member 1 and the second rotary member 2 are mounted on the connecting shaft 3. Axial positions of the first rotary member 1 and the second rotary member 2 are relatively fixed by a fixing device bearing 4, and can only move forward or backward as a whole in an axial direction and cannot separately or individually move in the axial direction. A first spiral groove 11 is provided in an inner wall of a shaft hole of the first rotary member 1. As shown in FIG. 2, a cylindrical first boss 31 mounted in conjunction with the first spiral groove 11 is disposed on the connecting shaft 3. There may be one or more cylindrical first bosses 31. To improve the connection stability between the first rotary member 1 and the connecting shaft 3, in this embodiment, there are two first bosses 31, and the two first bosses 31 are distributed on a spiral track line matching the first spiral groove 11. A second spiral groove 21 that rotates in an opposite direction from the first spiral groove 11 is provided in an inner wall of a shaft hole of the second rotary member 2, and a cylindrical second boss 32 mounted in conjunction with the second spiral groove 21 is disposed on the connecting shaft 3. There may be one or more cylindrical second bosses 32. To improve the connection stability between the second rotary member 2 and the connecting shaft 3, in this embodiment, there are two second bosses 32, and the two second bosses 32 are distributed on a spiral track line matching the second spiral groove 21.

A shape of each boss may be any shape that can match a spiral groove or a linear groove, and for example, may be a cylindrical shape, or a spiral boss shape matching the shape of the spiral groove. The bosses in this embodiment all adopt a cylindrical shape.

The rotary members may be rotary members in an eccentric mechanism, a gear train, an axle, or another device.

A method for adjusting the relative positions of the rotary members in a circumferential direction in the rotary member combination device in this embodiment is as follows.

The connecting shaft 3 is axially pushed to move forward or backward. Because the axial positions of the first rotary member 1 and the second rotary member 2 are fixed by the axial position fixing device bearing 4, the forward or backward movement of the connecting shaft 3 drives the first boss 31 and the second boss 32 on the connecting shaft 3 to move forward or backward, drives the first spiral groove 11 mounted in conjunction with the first boss 31 and the second spiral groove 21 mounted in conjunction with the second boss 32 to rotate opposite in the circumferential direction, and respectively drives the first rotary member 1 and the second rotary member 2 to rotate in opposite directions, so that the accurate adjustment of the relative positions of the first rotary member 1 and the second rotary member 2 in the circumferential direction is implemented.

### Embodiment 2

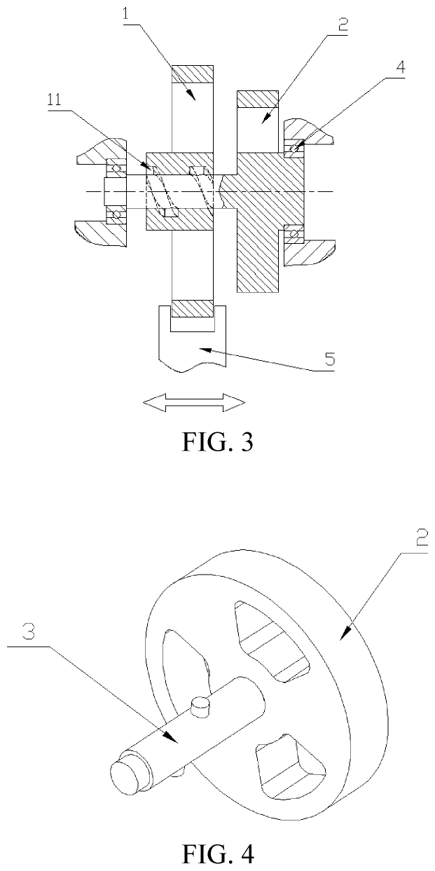

Embodiment 2 is the same as Embodiment 1 except that as shown in FIG. 3, the axial position of the second rotary member 2 is fixed on the connecting shaft 3 by the position fixing device bearing 4, whereas as shown in FIG. 4, the second rotary member 2 is integrated with the connecting shaft 3, and the spiral groove and a boss matching structure are no longer separately provided. The first rotary member 1 matches the connecting shaft 3 through the spiral groove and the boss structure in Embodiment 1. A first shifting device 5 is disposed on the first rotary member 1. The first shifting device 5 is shifted to make the first rotary member 1 move forward or backward in the axial direction of the connecting shaft 3 and rotate. The first shifting device 5 is a shifting fork, the shifting fork is provided with a U-shaped groove, and the first rotary member 1 is placed in the U-shaped groove of the shifting fork. The shifting fork actuates the first rotary member 1 to axially move to reach a specified position and locks the axial position of the first rotary member 1.

A method for adjusting the relative positions of the rotary members in the circumferential direction in the rotary member combination device in this embodiment is: shifting the first shifting device 5 to make the first rotary member 1 to move forward or backward on the connecting shaft 3, driving the first spiral groove 11 to move forward or backward, driving the first boss 31 to move forward or backward and rotate along a track line of the first spiral groove 11, driving the connecting shaft 3 to rotate, and driving the second rotary member 2 to rotate, so that the adjustment of the relative position in the circumferential direction and the adjustment of an axial interval between the first rotary member 1 and the second rotary member 2 is implemented.

### Embodiment 3

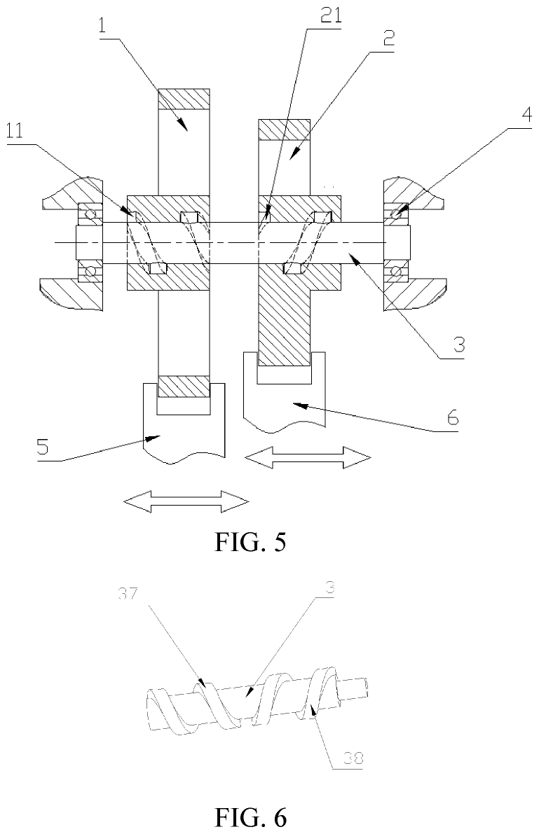

Embodiment 3 is the same as Embodiment 1 except that as shown in FIG. 5, an axial position of the connecting shaft 3 is fixed by the axial position fixing device bearing 4, neither the axial positions of the first rotary member 1 nor the second rotary member 2 is fixed, a first shifting device 5 is disposed on the first rotary member 1, and a second shifting device 6 is disposed on the second rotary member 2.

A method for adjusting the relative positions of the rotary members in the circumferential direction in the rotary member combination device in this embodiment is as follows.

The first shifting device 5 is shifted to move forward or backward, and drives the first rotary member 1 to move forward or backward in the axial direction. Because the axial position of the connecting shaft 3 is fixed, a movement of the first rotary member 1 in the axial direction drives the rotation of the connecting shaft 3 in the circumferential direction, and drives the second rotary member 2 to rotate in the circumferential direction. The second shifting device 6 is reversely shifted to move backward or forward. A reverse movement of the second rotary member 2 in the axial direction further drives the rotation of the connecting shaft 3 in the circumferential direction, and further drives the second rotary member 2 to rotate in the circumferential direction, so that the implementation of adjusting the relative positions of the two rotary members in the circumferential direction is accelerated, and the adjustment of the axial positions of the two rotary members is implemented at the same time, that is, the two rotary members approach or move away from each other at the same time.

### Embodiment 4

Embodiment 4 is the same as Embodiment 1 except that as shown in FIG. 6, the first boss 31 adopts the shape of a first spiral boss 37, the second boss 32 adopts the shape of a second spiral boss 38, and the first spiral boss 37 and the second spiral boss 38 have opposite rotation directions.

### Embodiment 5

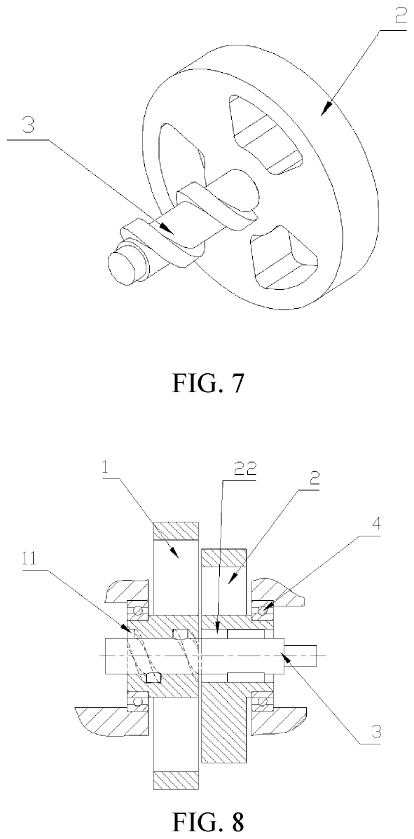

Embodiment 5 is the same as Embodiment 2 except that as shown in FIG. 7, the first boss 31 on the connecting shaft 3 adopts the spiral boss shape.

### Embodiment 6

Embodiment 6 is the same as Embodiment 3 except that as shown in FIG. 6, the first boss 31 adopts the shape of the first spiral boss 37, the second boss 32 adopts the shape of the second spiral boss 38, and the first spiral boss 37 and the second spiral boss 38 have opposite rotation directions.

### Embodiment 7

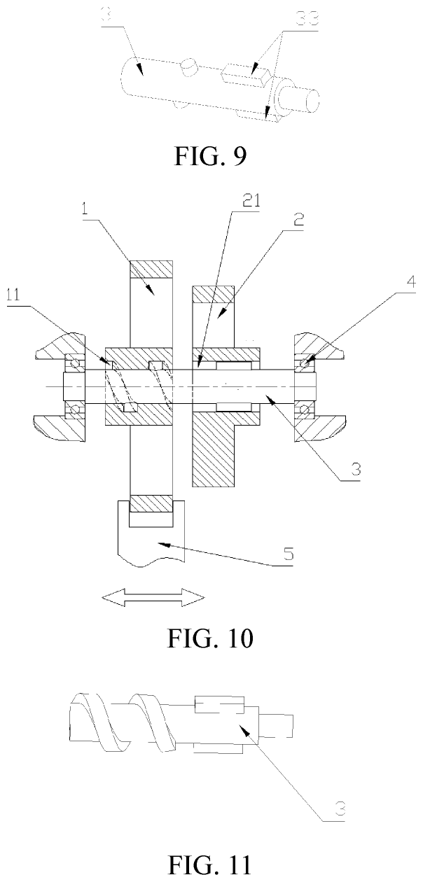

Embodiment 7 is the same as Embodiment 1 except that as shown in FIG. 8, a first linear groove 22 is provided in an inner wall of a shaft hole of the second rotary member 2 in place of the second spiral groove 21 in Embodiment 1. As shown in FIG. 9, a first linear boss 33 mounted in conjunction with the first linear groove 22 is disposed on the connecting shaft 3. There may be one or more first linear grooves 22, and correspondingly, there may be one or more first linear bosses 33. To improve the connection stability between the second rotary member 2 and the connecting shaft 3, there are two first linear grooves 22 in this embodiment. Preferably, the two first linear grooves 22 are equiangularly distributed in a circumferential direction of the inner wall of the shaft hole of the second rotary member 2. There are two first linear bosses 33, and the two first linear bosses 33 are distributed at positions matching the first linear grooves 22.

A method for adjusting the relative positions of the rotary members in the circumferential direction in the rotary member combination device in this embodiment is as follows.

The connecting shaft 3 is axially pushed to move forward or backward. Because the axial positions of the first rotary member 1 and the second rotary member 2 are fixed by the axial position fixing device bearing 4, the forward or backward movement of the connecting shaft 3 drives the first boss 31 and the first linear boss 33 on the connecting shaft 3 to move forward or backward, drives the first spiral groove 11 to rotate, and drives the first rotary member 1 to rotate while the second rotary member 2 remains stationary, so that the accurate adjustment of the relative positions of the first rotary member 1 and the second rotary member 2 in the circumferential direction is implemented.

### Embodiment 8

Embodiment 8 is the same as Embodiment 7 except that as shown in FIG. 10, the axial position of the connecting shaft 3 is fixed by the axial position fixing device bearing 4, neither the axial positions of the first rotary member 1 nor the second rotary member 2 is fixed, and a first shifting device 5 is disposed on the first rotary member 1.

A method for adjusting the relative positions of the rotary members in the circumferential direction in the rotary member combination device in this embodiment is: shifting the first shifting device 5 to move forward or backward, driving the first rotary member 1 to move forward or backward, driving the connecting shaft 3 to rotate, and driving the second rotary member 2 to rotate, so that the adjustment of the relative positions of the two rotary members in the circumferential direction is implemented, and the adjustment of the relative positions of the two rotary members in an axial direction is implemented at the same time.

### Embodiment 9

Embodiment 9 is the same as Embodiment 7 except that as shown in FIG. 11, the first boss 31 adopts the spiral boss shape.

### Embodiment 10

Embodiment 9 is the same as Embodiment 8 except that as shown in FIG. 11, the first boss 31 adopts the spiral boss shape.

### Embodiment 11

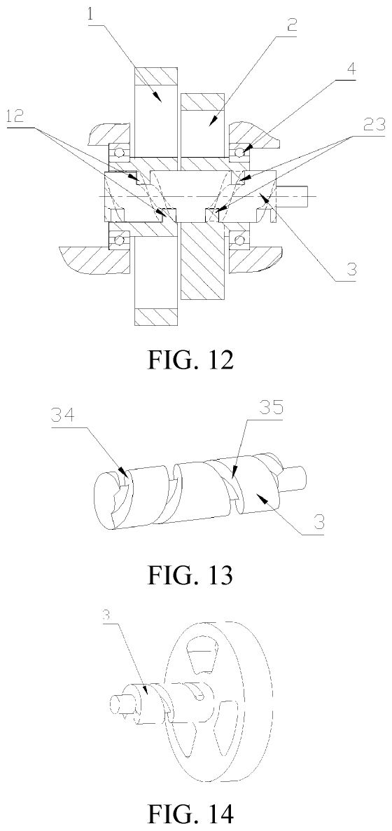

As shown in FIG. 12, the rotary member combination device includes a first rotary member 1, a second rotary member 2, and a connecting shaft 3. The first rotary member 1 and the second rotary member 2 are mounted on the connecting shaft 3. The axial positions of the first rotary member 1 and the second rotary member 2 are relatively fixed by the fixing device bearing 4, and can only move forward or backward as a whole in an axial direction and cannot separately or individually move in the axial direction. As shown in FIG. 13, a third spiral groove 34 is provided in the connecting shaft 3, and a third boss 12 mounted in conjunction with the third spiral groove 34 is disposed on the first rotary member 1. There may be one or more third bosses 12. To improve the connection stability between the first rotary member 1 and the connecting shaft 3, in this embodiment, there are two third bosses 12, and the two third bosses 12 are distributed on a spiral track line matching the third spiral groove 34. A fourth spiral groove 35 that rotates in an opposite direction from the third spiral groove 34 is provided in the connecting shaft 3, and a fourth boss 23 mounted in conjunction with the fourth spiral groove 35 is disposed on the second rotary member 2. There may be two or more fourth bosses 23. In this embodiment, there are two fourth bosses 23, and the two fourth bosses 23 are distributed on a spiral track line matching the fourth spiral groove 35.

A method for adjusting the relative positions of the rotary members in the circumferential direction in the rotary member combination device in this embodiment is as follows.

The connecting shaft 3 is axially pushed to move forward or backward. Because the axial positions of the first rotary member 1 and the second rotary member 2 are fixed by the axial position fixing device bearing 4, the forward or backward movement of the connecting shaft drives the third spiral groove 34 and the fourth spiral groove 35 on the connecting shaft to move forward or backward, drives the third boss 12 and the fourth boss 23 to rotate in opposite directions, and drives the first rotary member and the second rotary member to rotate in opposite directions, so that the accurate adjustment of the relative positions of the two rotary members in the circumferential direction is implemented.

### Embodiment 12

Embodiment 12 is the same as Embodiment 11 except that as shown in FIG. 14, the second rotary member 2 is integrated with the connecting shaft 3, and the spiral groove and a boss matching structure are no longer separately provided. The first rotary member 1 matches the connecting shaft 3 through the spiral groove and the boss structure in Embodiment 11. A first shifting device is disposed on the first rotary member 1. The first shifting device is shifted to make the first rotary member 1 move forward or backward in the axial direction of the connecting shaft 3 and rotate.

A method for adjusting the relative positions of the rotary members in the circumferential direction in the rotary member combination device in this embodiment is the same as the adjustment method in Embodiment 2.

### Embodiment 13

Embodiment 13 is the same as Embodiment 11 except that the axial position of the connecting shaft 3 is fixed by the axial position fixing device bearing 4, neither the axial positions of the first rotary member 1 nor the second rotary member 2 is fixed, and a first shifting device is disposed on the first rotary member 1, and a second shifting device is disposed on the second rotary member 2.

A method for adjusting the relative positions of the rotary members in the circumferential direction in the rotary member combination device in this embodiment is the same as the adjustment method in Embodiment 3.

### Embodiment 14

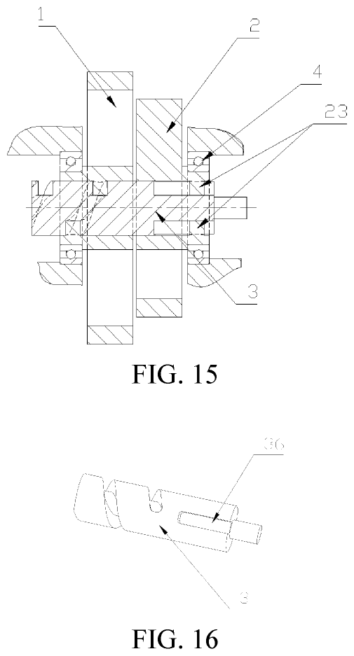

Embodiment 14 is the same as Embodiment 11 except that as shown in FIG. 16, a second linear groove 36 is provided in the connecting shaft 3 in place of the fourth spiral groove 35, whereas as shown in FIG. 15, a fourth boss 23 mounted in conjunction with the second linear groove 36 is disposed on the second rotary member 2. There may be one or more second linear grooves 36, and there may be one or more fourth bosses 23. To improve the connection stability between the second rotary member 2 and the connecting shaft 3, in this embodiment, there are two second linear grooves 36, and the two second linear grooves 36 are equiangularly distributed in a circumferential direction of the connecting shaft; and there are two fourth bosses 23, and the two fourth bosses 23 are distributed at positions matching the second linear grooves 36.

A shape of each boss may be any shape that can be mounted in conjunction with the spiral groove or the linear groove, and for example, may be a cylindrical shape, or a spiral boss shape matching the shape of the spiral groove.

A method for adjusting the relative positions of the plurality of rotary members in the circumferential direction in the rotary member combination device in this embodiment is as follows.

The connecting shaft 3 is axially pushed to move forward or backward. Because the axial positions of the first rotary member 1 and the second rotary member 2 are fixed by the axial position fixing device bearing 4, the forward or backward movement of the connecting shaft 3 drives the third spiral groove 34 and the second linear groove 36 on the connecting shaft to move forward or backward, drives the third boss 12 to rotate, and drives the first rotary member 1 to rotate while the fourth boss 23 remains stationary in the second linear groove 36 and the second rotary member 2 remains stationary, so that the accurate adjustment of the relative positions of the two rotary members in the circumferential direction is implemented.

### Embodiment 15

Embodiment 15 is the same as Embodiment 14, except that the axial position of the connecting shaft 3 is fixed by the axial position fixing device bearing, neither the axial positions of the first rotary member 1 nor the second rotary member 2 is fixed, and a first shifting device is disposed on the first rotary member 1.

A method for adjusting the relative positions of the rotary members in the circumferential direction in the rotary member combination device in this embodiment is the same as the adjustment method in Embodiment 8.

1. A rotary member combination device, comprising at least a first rotary member and a second rotary member, and further comprising a connecting shaft between the first rotary member and the second rotary member,
wherein at least one of the first rotary member or the second rotary member is connected to the connecting shaft by a spiral groove and a boss structure matching the spiral groove.

2. The rotary member combination device according to claim 1, wherein a first spiral groove is provided in an inner wall of a shaft hole of the first rotary member, and a first boss matching the first spiral groove is disposed on the connecting shaft.

3. The rotary member combination device according to claim 2, wherein the second rotary member is fixedly connected to the connecting shaft, and a first shifting device is disposed on the first rotary member.

4. The rotary member combination device according to claim 3, wherein the second rotary member is integrated with the connecting shaft, a front end is the connecting shaft, and a rear end is the second rotary member.

5. The rotary member combination device according to claim 3, wherein the first shifting device is a shifting fork, the shifting fork is provided with a U-shaped groove, and the first rotary member is located in the U-shaped groove of the shifting fork.

6. The rotary member combination device according to claim 2, wherein an axial position of the connecting shaft is fixed by an axial position fixing device bearing, a second spiral groove that rotates in an opposite direction from the first spiral groove is provided in an inner wall of a shaft hole of the second rotary member, and a second boss matching the second spiral groove is disposed on the connecting shaft.

7. The rotary member combination device according to claim 6, wherein a first shifting device is disposed on the first rotary member.

8. The rotary member combination device according to claim 7, wherein a second shifting device is disposed on the second rotary member.

9. The rotary member combination device according to claim 1, wherein an axial position of the connecting shaft is fixed by an axial position fixing device bearing, a third spiral groove is provided in the connecting shaft, and a third boss mounted in conjunction with the third spiral groove is disposed on the first rotary member; and a fourth spiral groove that rotates in an opposite direction from the third spiral groove is provided in the connecting shaft, and a fourth boss mounted in conjunction with the fourth spiral groove is disposed on the second rotary member, and a first shifting device is disposed on the first rotary member.

10. The rotary member combination device according to claim 1, wherein an axial position of the connecting shaft is fixed by an axial position fixing device bearing, a third spiral groove is provided in the connecting shaft, and a third boss mounted in conjunction with the third spiral groove is disposed on the first rotary member; and a second linear groove is provided in the connecting shaft, a fourth boss mounted in conjunction with the second linear groove is disposed on the second rotary member, and a first shifting device is disposed on the first rotary member.

11. The rotary member combination device according to claim 9, wherein a second shifting device is disposed on the second rotary member.

12. The rotary member combination device according to claim 2, wherein axial positions of the first rotary member and the second rotary member are fixed by a fixing device.

13. The rotary member combination device according to claim 12, wherein a second spiral groove that rotates in an opposite direction from the first spiral groove is provided in an inner wall of a shaft hole of the second rotary member, and a second boss matching the second spiral groove is disposed on the connecting shaft.

14. The rotary member combination device according to claim 13, wherein a shape of each of the first boss and the second boss is a cylindrical shape; there are at least two first bosses, and the at least two first bosses are distributed on a spiral track line matching the first spiral groove; and there are at least two second bosses, and the at least two second bosses are distributed on a spiral track line matching the second spiral groove.

15. The rotary member combination device according to claim 12, wherein a first linear groove is provided in an inner wall of a shaft hole of the second rotary member, and a second boss mounted in conjunction with the first linear groove is disposed on the connecting shaft.

16. The rotary member combination device according to claim 15, wherein there are two or more first bosses, and the two or more first bosses are distributed on a spiral track line matching the first spiral groove; and there are two or more second bosses, and the two or more second bosses are distributed on a track line matching the first linear groove.

17. The rotary member combination device according to claim 1, wherein axial positions of the first rotary member and the second rotary member are fixed by a fixing device, a third spiral groove is provided in the connecting shaft, and a third boss mounted in conjunction with the third spiral groove is disposed on the first rotary member.

18. The rotary member combination device according to claim 17, wherein a fourth spiral groove that rotates in an opposite direction from the third spiral groove is provided in the connecting shaft, and a fourth boss mounted in conjunction with the fourth spiral groove is disposed on the second rotary member.

19. The rotary member combination device according to claim 17, wherein a second linear groove is provided in the connecting shaft, and a fourth boss mounted in conjunction with the second linear groove is disposed on the second rotary member.

20. The rotary member combination device according to claim 18, wherein there are two or more third bosses, and the two or more third bosses are distributed on a spiral track line matching the third spiral groove and there are two or more fourth bosses, and the two or more fourth bosses are distributed on a spiral track line matching the fourth spiral groove.

21. The rotary member combination device according to claim 19, wherein there are two or more third bosses, and the two or more third bosses are distributed on a spiral track line matching the third spiral groove and there are two or more fourth bosses, and the two or more fourth bosses are distributed on a track line matching the second linear groove.

22. A connecting shaft of the rotary member combination device according to claim 1, wherein the connecting shaft is provided with a first boss matching the first rotary member of the rotary member combination device.

23. The connecting shaft according to claim 22, wherein the first boss is a cylinder.

24. The connecting shaft according to claim 23, wherein there are two or more first bosses, and the two or more first bosses are disposed on a track line of the first spiral groove.

25. The connecting shaft according to claim 23, wherein the connecting shaft is fixedly connected to the second rotary member of the rotary member combination device.

26. The connecting shaft according to claim 23, wherein the connecting shaft is provided with a cylindrical second boss matching the second rotary member of the rotary member combination device.

27. The connecting shaft according to claim 26, wherein there are two or more second bosses, and the two or more second bosses are disposed on a second spiral track line rotating in an opposite direction from the first spiral groove.

28. The connecting shaft according to claim 23, wherein the connecting shaft is provided with a first linear boss matching the second rotary member of the rotary member combination device.

29. The connecting shaft according to claim 28, wherein there are two or more first linear bosses, and the two or more first linear bosses are equiangularly distributed in a circumferential direction of the connecting shaft.

30. The connecting shaft according to claim 22, wherein the first boss is a first spiral boss.

31. The connecting shaft according to claim 30, wherein the connecting shaft is fixedly connected to the second rotary member of the rotary member combination device.

32. The connecting shaft according to claim 30, wherein the connecting shaft is provided with a second spiral boss matching the second rotary member of the rotary member combination device.

33. The connecting shaft according to claim 30, wherein the connecting shaft is provided with a first linear boss matching the second rotary member of the rotary member combination device.

34. A connecting shaft of the rotary member combination device according to claim 1, wherein the connecting shaft is provided with a third spiral groove matching the first rotary member of the rotary member combination device.

35. The connecting shaft according to claim 34, wherein a fourth spiral groove that rotates in an opposite direction from the third spiral groove is provided in the connecting shaft.

36. The connecting shaft according to claim 34, wherein the connecting shaft is fixedly connected to the second rotary member of the rotary member combination device.

37. The connecting shaft according to claim 34, wherein a second linear groove is provided in the connecting shaft.

38. The connecting shaft according to claim 37, wherein there are two or more second linear grooves, and the two or more second linear grooves are equiangularly distributed in a circumferential direction of the connecting shaft.
